(19) United States
(12) Patent Application Publication
(10) Pub. No.: US 2021/0381424 A1
(43) Pub. Date: Dec. 9, 2021

(54) DEVICE FOR ROLLING MOTION BY ENERGY FROM FUEL-OIL COMBUSTION

(71) Applicant: Hamit AYKAÇ, Ankara (TR)

(72) Inventor: Hamit AYKAÇ, Ankara (TR)

(21) Appl. No.: 17/286,856

(22) PCT Filed: Oct. 15, 2019
(86) PCT No.: PCT/TR2019/050869

§ 371 Date: Apr. 20, 2021

(30) Foreign Application Priority Data
Oct. 24, 2018 (TR) 2018/15836

(51) Int. Cl. F02B 53/10; F02B 53/12; F02B 55/14; F01N 13/10; F02M 25/00; F01M 11/02; F02F 1/10; F02F 1/04

(52) U.S. Cl. CPC F02B 53/10; F02B 53/12; F02B 55/14; F02F 1/04; F02M 25/00; F01M 11/02; F02F 1/10; F01N 13/10

(57) ABSTRACT

A device wherein rolling motion is obtained by energy obtained as a result of combustion of solid, liquid or gas fuel oil. The device has an elliptic disc installed onto a symmetric ball on a ball shaft in a body. A fuel oil injector inlet channel and ignition bobbin inlet channels are provided in the body. A rolling wall is installed onto the body and an exhaust outlet pipe. The rolling wall separates a symmetric body chamber into a suction chamber and combustion chamber. In one cycle rolling of elliptic disk, fuel-oil taken into the suction chamber is transferred to combustion chamber. Fuel oil taking and fuel-oil compressing and explosion thereof by ignition is conducted simultaneously and continuously and not interrupted.

Invention relates to a device wherein rolling/cyclic motion is obtained by energy released as a result of combustion of solid, liquid or gas fuel oil

Comprising an elliptic disc installed between ball consisting of two symmetric parts on ball shaft extending into body comprising symmetric two parts,

Wherein fuel oil injector is placed in fuel oil injector inlet channel and firing bobbins into firing bobbin inlet channels comprising fuel oil injector inlet channel and firing bobbin inlet channels in body,

An exhaust output pipe inserted into exhaust output channel inside body,

Comprising a rolling wall inserted into rolling wall inlet channel on body, wherein rolling wall separates body chamber it enters into equal volume suction chamber and combustion chamber,

Elliptic disk forced to do rolling motion by fuel-oil sprayed into suction chamber,

Elliptic disk contacting rolling wall and making rolling/cyclic motion at horizontal position not circular rotation

As a result of one cycle rolling of elliptic disk, suction chamber fuel-oil taken into suction chamber is transferred to combustion chamber,

Explosion is achieved as a result of heat of fuel-oil compressed by elliptic disk in combustion chamber and start of ignition from bobbin,

Discharge of exhaust gas from explosion to external environment via exhaust gas pipe,

Fuel oil inlet into combustion chamber where process is performed is prevented in stage of fuel-oil compression and burning in combustion chamber,

With the pressure created by explosion in combustion chamber, elliptic disk touches rolling wall and upon progressing, fuel-oil entering suction chamber is transferred back to combustion chamber,

Fuel oil taking and fuel-oil compressing and explosion thereof by ignition is conducted simultaneously and continuously and not interrupted,

Rolling/oscillation of symmetric ball and shaft where to symmetric ball is connected upon rolling of elliptic disk by pressure created in combustion chamber by explosion

Shaft making oscillation/rolling gain motion capability/motion energy,

Shaft motions are transferred to apparatus by means of spindle, pipe and similar apparatus to be connected to shaft when required,

### BACKGROUND OF THE RELATED ART

Spindles, pistons and similar apparatus make circular motion or linear motion by help of force of energy generated from combustion of fuel-oil entering chambers. Circular motion energy or linear motion energy are transferred to related apparatus.

There is no device in which energy generated from burned fuel-oil provides rolling motion capability/rolling motion.

### PURPOSE OF THE INVENTION

Purpose of the invention is:
1. Provide continuous, uninterrupted flow of solid, liquid or gas fuel oil into suction chamber,
2. Use solid, liquid or gas fuel oil of higher volume/flow rate,
3. To divide body chamber of device into two equal volumes by rolling wall and create co-time and co-volume (burning fuel oil in the quantity of absorbed amount) system
4. To conduct rolling/oscillation of symmetric ball and shaft upon rolling of elliptic disk by pressure created in combustion chamber by explosion and to achieve rolling movement ability.
5. To provide high efficiency as a result of above mentioned features and thus save from time and cost.

Invention is characterized in comprising:
1. Comprising symmetric two-part body and ball shaft,
2. Ball shaft inserted inside body comprises elliptic disk placed between two symmetric balls installed onto shaft,
3. Comprising rolling wall installed to body externally and separating body volume into two equal areas,
4. Rolling wall forms suction chamber and combustion chamber inside body wherein it enters,
5. Comprising fuel oil injector installed externally to body and transmitting fuel oil and fuel oil igniting bobbins giving ignition to fuel oil compressed into combustion chamber and heated,
6. Discharge of gas generating after explosion initiated by ignition started with igniting fuel oil compressed and heated in combustion chamber through exhaust gas discharge pipe,
7. Explosion in combustion chamber, pressure/compression application onto elliptic disk by pressure and initiation of movement,
   Moving elliptic disk is prevented from completing one tour by contacting the rolling wall and moving back and forth in horizontal position on rolling wall surface, conduct of fuel oil absorption and synchronous and isochoric compression with combustion operation, providing persistency
8. Elliptic disk exposed to gas pressure upon combustion contacts rolling wall and conchannels oscillating movement and shaft whereto elliptic disk is connected makes rolling/oscillating movement and when required rolling movement is transferred to organs/apparatus outside device,
9. Body sides comprise cooling wings for cooling the heated body by use of air
10. Comprising lubrication channels facilitating friction and preventing rusting in body, 11. Comprising cooling-heating channels having hot-cold liquid in order to match outside temperature, to cool heated body or heat cooled body

The figures prepared to make better understanding of the invention are as follows:

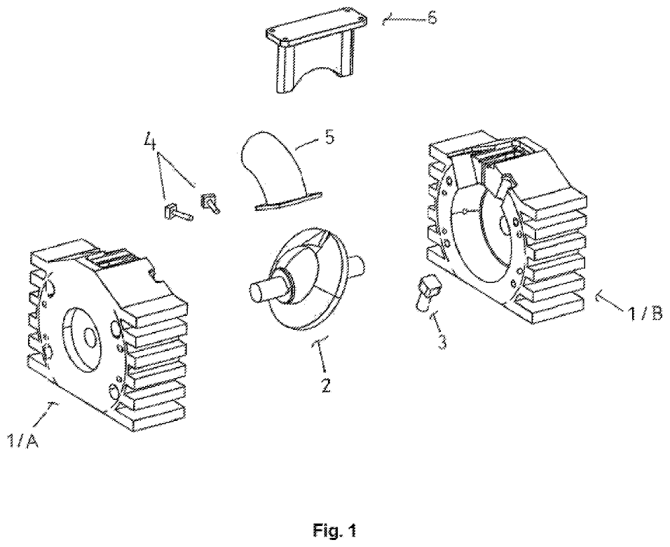

FIG. 1 is a perspective view of demounted status of device parts given rolling/oscillating movement by energy generated by combustion of solid, liquid or gas fuel oil,

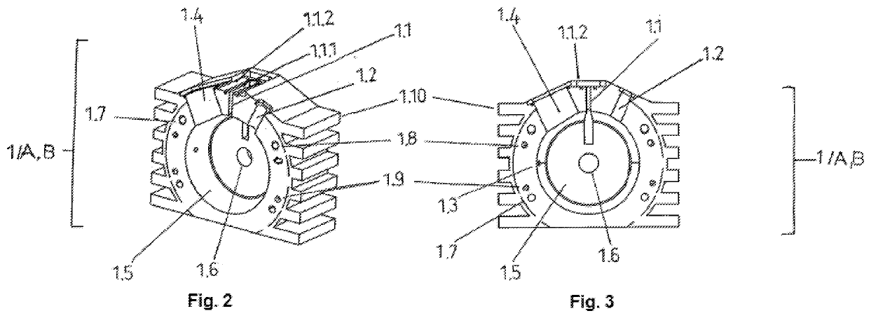

FIG. 2 is perspective inside view of a part of the body,

FIG. 3 is perspective cross-section view of a part of the body,

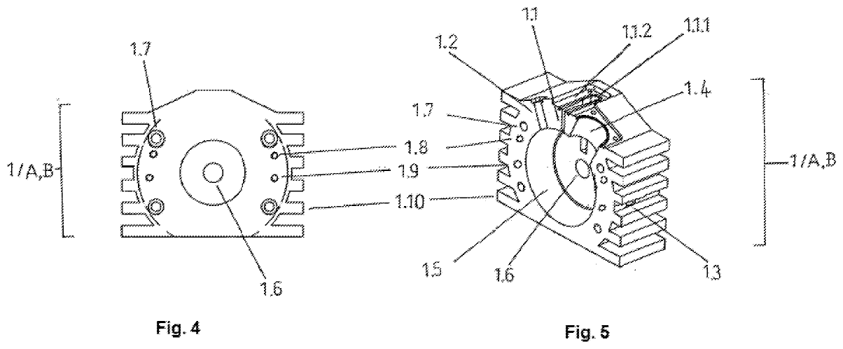

FIG. 4 is front view of a part of the body,

FIG. 5 is perspective inside view of a part of the body from other direction,

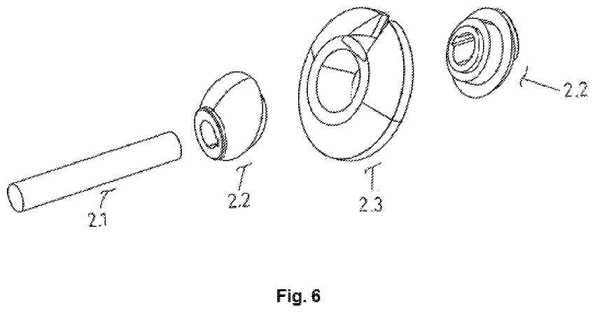

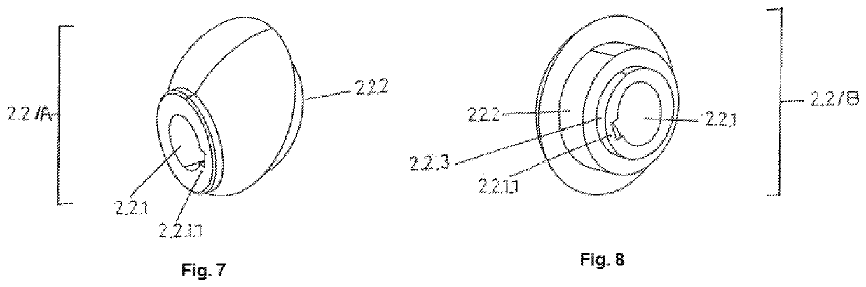

FIG. 6 is perspective view of demounted parts forming ball shaft FIG. 7 is perspective outer view of a part of symmetric ball,

FIG. 8 is perspective inner view of a part of symmetric ball,

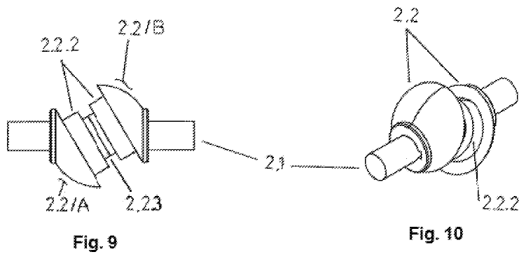

FIG. 9 is a front view of symmetric ball installed to shaft,

FIG. 10 is a perspective view of symmetric ball installed to shaft,

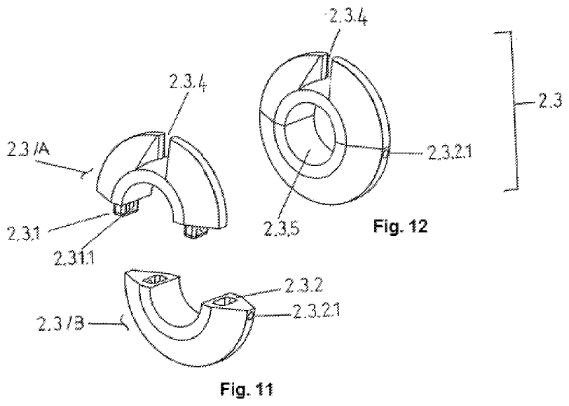

FIG. 11 is a perspective view of two-piece demounted elliptic disk FIG. 12 is a perspective view of mounted elliptic disk,

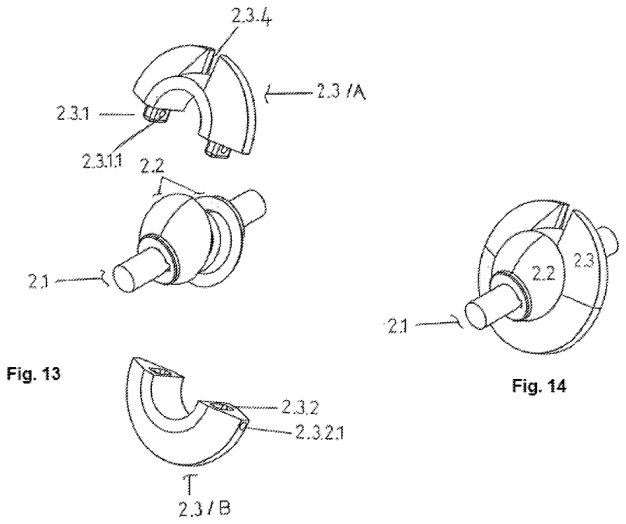

FIG. 13 is a perspective view of demounted position of two-piece elliptic disk together with symmetric ball (2.2) with shaft (2.1) inserted

FIG. 14 is a perspective view of elliptic disk, shaft and symmetric ball in mounted position

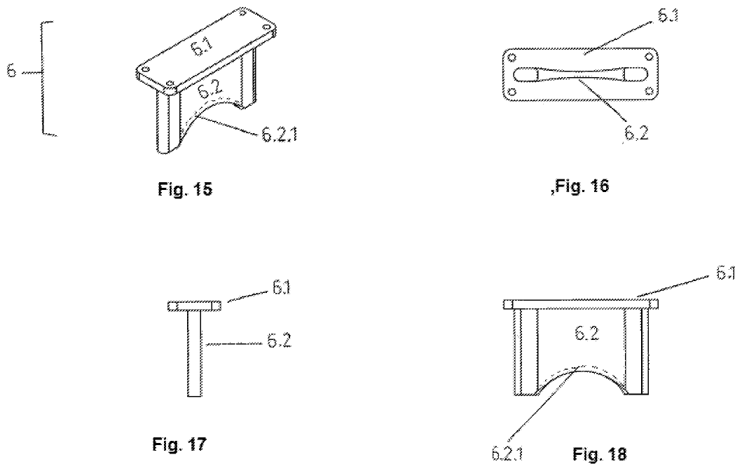

FIG. 15 is a perspective view of rolling wall,

FIG. 16 is a lower view of rolling wall,

FIG. 17 is a front view of rolling wall,

FIG. 18 is a side view of rolling wall,

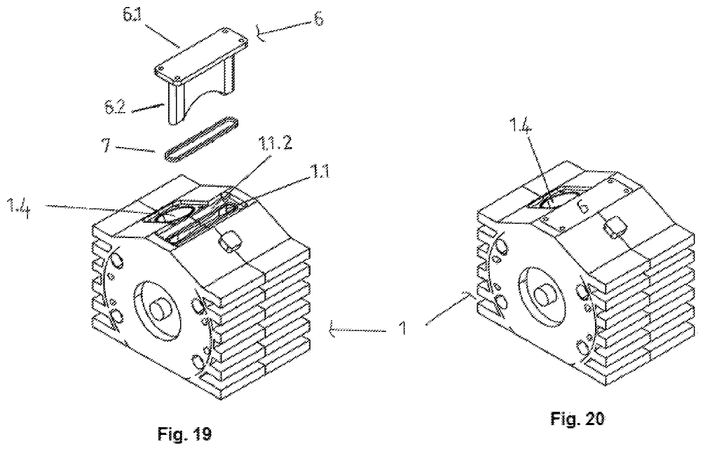

FIG. 19 is a perspective view of body and rolling wall in demounting position,

FIG. 20 is a perspective view of body and rolling wall in mounting position,

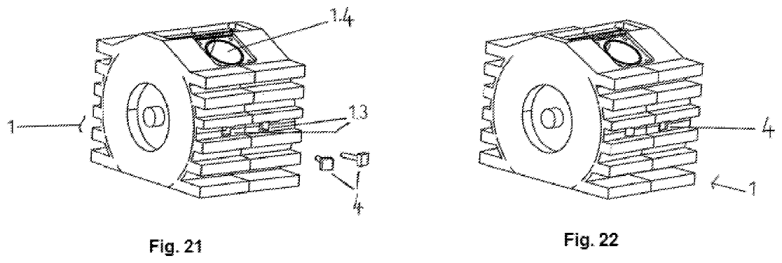

FIG. 21 is a perspective view of body and ignition bobbins in demounting position,

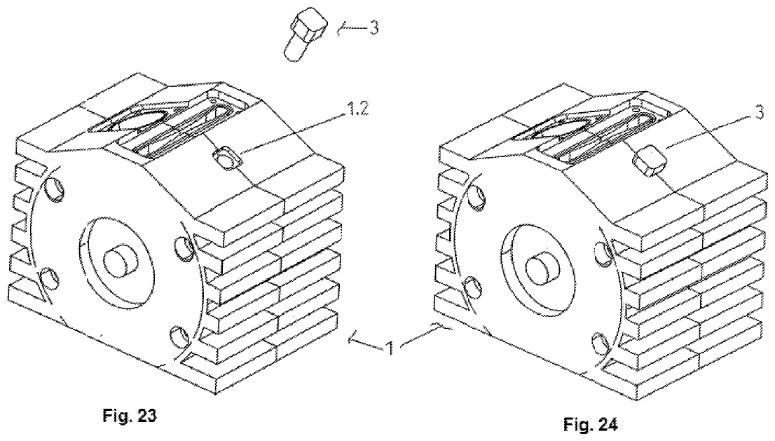

FIG. 22 is a perspective view of body and ignition bobbins in mounting position,

FIG. 23 is a perspective view of body and fuel oil injector in demounting position,

FIG. 24 is a perspective view of body and fuel oil injector in mounting position,

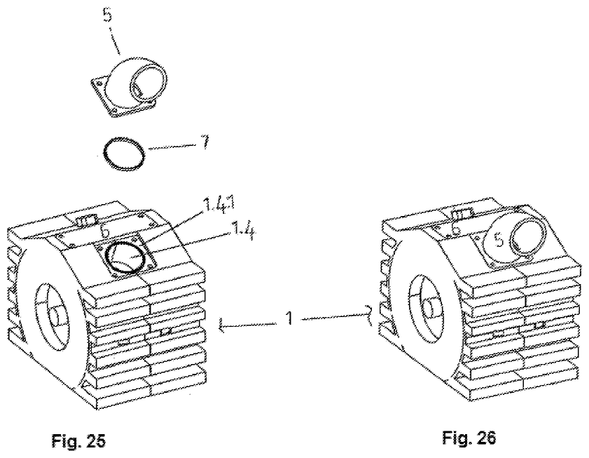

FIG. 25 is a perspective view of body and exhaust output pipe in demounting position,

FIG. 26 is a perspective view of body and exhaust output pipe in demounting position,

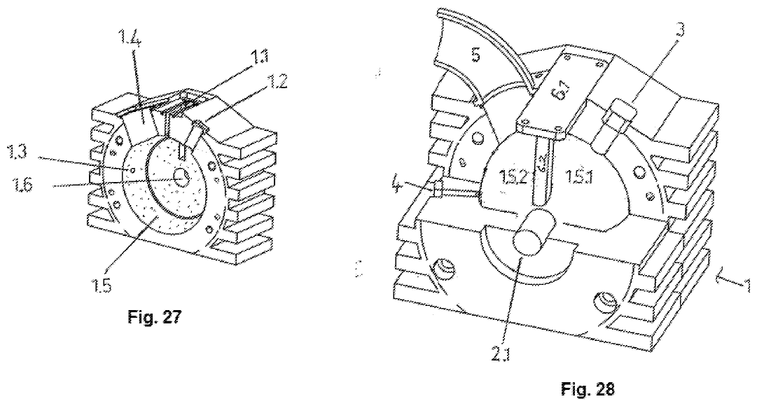

FIG. 27 is a perspective view of body chamber,

FIG. 28 is a semi-cross-section perspective view of rolling wall dividing body chamber into two equal volume chambers,

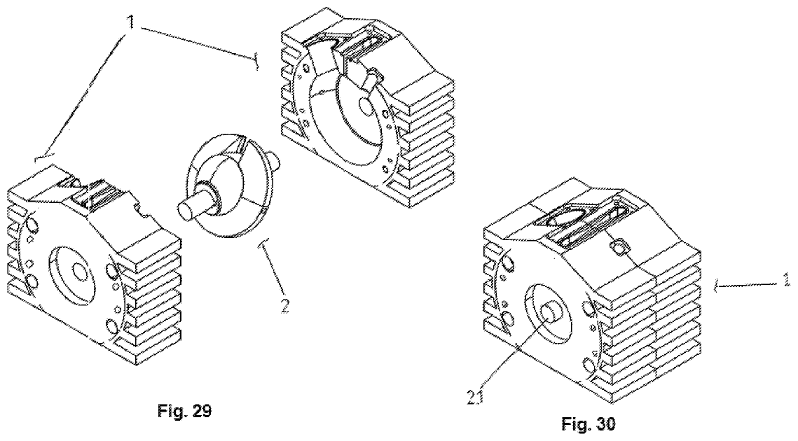

FIG. 29 is a perspective view of body parts not installed accessories and ball shaft in demounting position,

FIG. 30 is a perspective view of body parts not installed accessories and ball shaft in mounting position,

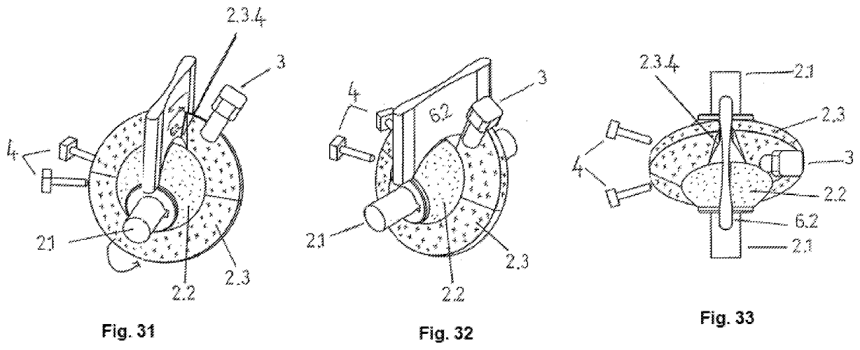

FIG. 31 is a front perspective view of rolling wall on ball shaft,

FIG. 32 is a side perspective view of rolling wall on ball shaft,

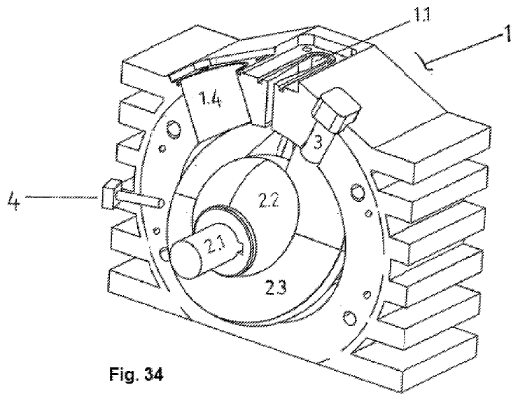

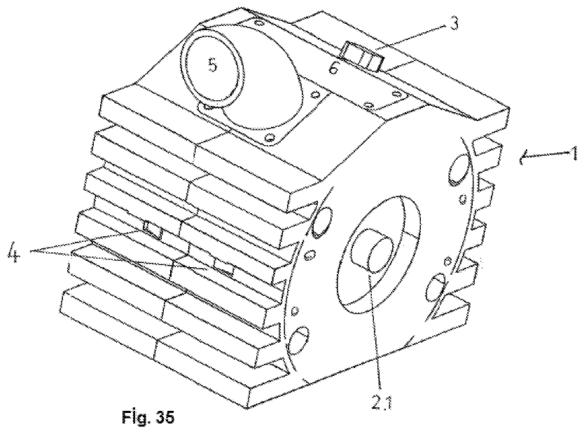

FIG. 33 is a top perspective view of rolling wall on ball shaft,

FIG. 34 is a perspective view of ball shaft inside body not having rolling wall inserted,

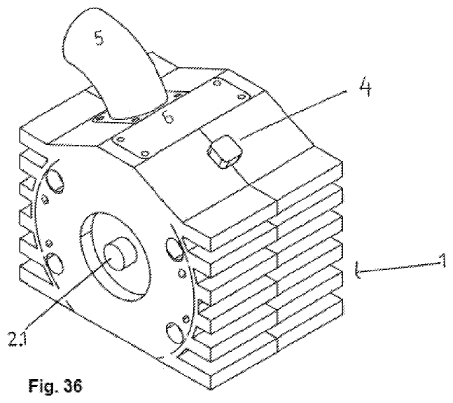

FIG. 35 is a side perspective view of body with accessories installed,

FIG. 36 is a other side perspective view of body with accessories installed,

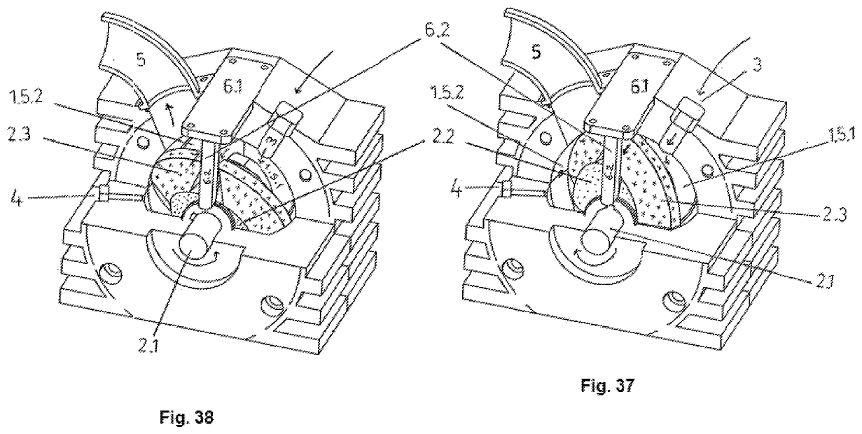

FIG. 37 is a semi-cross-sectional view of fuel oil spraying to suction chamber,

FIG. 38 is a semi cross-sectional view of fuel oil compression upon progress of elliptic disk in suction chamber by pressure and narrowing area of elliptic disk in fuel oil chamber and compression of fuel oil,

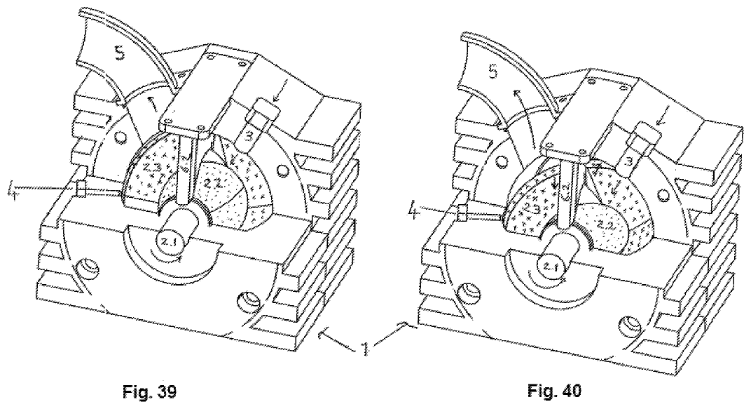

FIG. 39 is a semi cross-sectional view of explosion of fuel oil compressed in fuel oil chamber and inlet of fuel oil into suction chamber again,

FIG. 40 is a semi cross-sectional view of discharge of gas generating in in fuel oil chamber and supply of fuel oil from combustion chamber again,

Each part is assigned a separate number in figures for better understanding of the invention. Description of each part assigned a number is as follows:
1—Body
1/A Left body
1/B—right body
1.1—Rolling wall inlet channel,
1.1.1—Rolling wall inlet channel insulation housing,
1.1.2—Rolling wall seating surface,
1.2—Fuel oil injector inlet channel,
1.3. Ignition bobbin inlet channel,
1.4—Exhaust output channel,
1.4.1. Exhaust output channel o-ring housing
1.5—Body chamber,
1.5.1. Suction chamber,
1.5.1. Combustion chamber,
1.6—Shaft inlet channel
1.7—Body connection hole,
1.8—Cooler—heater channel
1.9—Lubrication channel
1.10. Cooling wing,
2—Ball shaft,
2.1—Shaft,
2.2—Symmetric ball,
2.2/A Left ball
2.2/B right ball
2.2.1—Shaft passing channel
2.2.1.1 Shaft fixing tab,
2.2.2—Disk seating surface,
2.2.3—Ball contact surface,
2.3. Elliptic disk,
2.3/A Upper disk,
2.3/B Lower disk,
2.3.1. Tab,
2.3.1.1. Tab pressing hole,
2.3.2. Tab housing,
2.3.2.1. Tab housing pressing hole,
2.3.4—Rolling wall seating chamber,
2.3.5—Shaft clutching channel
5.3. Fuel oil injector,
4—Ignition bobbin
5—Exhaust output pipe,
6—Rolling wall,
6.1—Cover,
6.2. Concave wall,
6.2.1. Rolling wall o-ring channel
7—O-ring.

Device wherein rolling/oscillating motion is obtained by means of energy generating as a result of solid, liquid or gas fuel-oil combustion comprises main parts/accessories consisting of a body (1), ball shaft (2), fuel oil injector (3), ignition bobbins (4), exhaust output pipe (5) and rolling wall (6).

FIG. 1 shows a perspective view of demounted status of device parts given rolling/oscillating movement by energy generated by combustion of solid, liquid or gas fuel oil,

Same part numbers are assigned to the parts of left body (1.A) and right body (1.B). It is aimed to make description easy to understand and to avoid doubt in description as they are symmetric of each.

Body (1) comprises two equal parts: Left body (1/A) and right body (1/B). Internal perspective view of a part out of two-piece body (1) belonging to body (1) is shown in FIG. 2, cross-sectional view of a part belonging to body (1) is given in FIG. 3 and front view of a art belonging to body (1) is shown in FIG. 4, internal other side perspective view of a part belonging to body (1) is shown in FIG. 5.

FIG. 2, FIG. 3, FIG. 4 and FIG. 5 show equal parts (1/A,B) of the body (1).

The body (1) has rolling wall inlet channel (1.1) wherein rolling wall (6) enters, and rolling wall surface (1.1.2) where cover (6.1) sits. O-ring (7) is placed into rolling wall inlet channel insulation housing (1.1.1) and insulation is provided.

Fuel oil injector inlet channel (1.2) wherein fuel oil injector (3) enters and sprays fuel oil,

Ignition bobbin inlet channels (1.3) where ignition bobbins (4) give ignition,

Exhaust outlet channel (1.4) where exhaust outlet pipe (5) is connected, Shat inlet channel (1.6) where shaft (2.1) is connected, Body connection holes (1.7) where left body (1/A) and right body (1/B) interconnect, Cooler-heater channels (1.8) for cooling or heating of body (1) by liquid, Lubrication channels (1.9) to prevent rust of body (1),

Cooling channels (1.10) on outer surface sides for cooling body (1) in outer environment are provided.

When left body (1/A) and right body (1/B) combine, body chamber (1.5) wherein ball shaft (2) enters is formed.

Perspective view of parts forming ball shaft (2) in demounting position is given in FIG. 6.

Ball shaft (2) comprises a shaft (2.1) two facing symmetric balls (2.2) and elliptic disk (2.3).

Outer perspective view of a part of the symmetric ball (2.2) is shown in FIG. 7, inner perspective view of a part of symmetric ball (2.2) is given in FIG. 8, front view of symmetric ball (2.2) where connected to shaft (2.1) is given in FIG. 9 and perspective view of symmetric ball (2.2) where connected to shaft (2.1) is shown in FIG. 10.

Shaft (2.1) is the apparatus whereon left ball (2.2/A) and right ball (2.2/B) are installed.

Symmetric ball (2.2) comprises left ball (2.2/A) and right ball (2.2/B). Symmetric ball (2.2) comprises shaft fixing tab (2.2.1.1) clutching shaft (2.1) on inner surface and disk seating surface (2.2.2) and ball contact surface (2.2.3).

Facing two-part symmetric ball (2.2) to provide oscillation and in angle is located on shaft (2.1). Disk seating surface (2.2.2) clutched by elliptic disk (2.3) between left ball (2.2/A) and right ball (2.2/B) is formed.

Perspective view of two-part elliptic disk (2.3) in demounted position is given in FIG. 11 and perspective view of elliptic disk (2.3) in mounted position is given in FIG. 12.

Elliptic disk (2.3) comprises upper disk (2.3/A) and lower disk (2.3/B).

Upper part of elliptic disk (2.3), that is, upper disk (2.3/A) facing tabs (2.3.1) having tab pressing hole (2.3.1.1) thereon and rolling wall seating chamber (2.3.4) where elliptic disk (2.3) enters.

Lower part of elliptic disk (2.3), that is lower disk (2.3/B) contains facing tab housings (2.3.2) having tab housing pressing hole (2.3.2.1).

Shaft clutching channel (2.3.5) is formed by combination of upper disk (2,3/A) and lower disk (2.3/B).

Perspective view of two-part elliptic disk (2.3) with shaft (2.1) installed together with symmetric ball (2.2) in demounting position is shown in FIG. 13 and perspective view of elliptic disk (2.3), shaft (2.1) and symmetric ball (2.2) in mounting position is shown in FIG. 14.

Perspective view of rolling wall (6) is given in FIG. 15, lower view of rolling wall (6) is given in FIG. 16, front view of rolling wall (6) is shown in FIG. 17 and side view of rolling wall (6) is shown in FIG. 18.

Rolling wall (6) is formed by mounting vertical positioned concave wall (6.2) onto horizontal located cover (6.1). Rolling wall o-ring channel (6.2.1) is formed to provide insulation on lower surface of concave wall (6.2). Rolling wall o-ring channel (6.2.1) is shown with dots in FIG. 15 and FIG. 18.

Mounting of device parts onto symmetric body (1):

Perspective view of body (1) and rolling wall (6) in demounting position is given in FIG. 19, perspective view of body (1) and rolling wall (6) in mounting position is shown in FIG. 20.

O-ring (7) is located into rolling wall inlet channel insulation housing (1.1.1) in order to provide insulation.

Rolling wall (6) is inserted into symmetric body (1) from concave wall (6.2) through rolling wall inlet channel (1.1). The cover (6.1) is located in a manner to contact rolling wall seating surface (1.1.2).

Perspective view of body (1) and ignition bobbins (4) in demounting position is given in FIG. 21, perspective view of body (1) and ignition bobbins (4) in mounting position is shown in FIG. 22.

Ignition bobbins (4) are located into ignition bobbin inlet channels (1.3) in the body (1)

Perspective view of body (1) and fuel oil injector (3) in demounting position is given in FIG. 23, perspective view of body (1) and fuel oil injector (3) in mounting position is shown in FIG. 24.

Fuel oil injector (3) is located into fuel oil injector inlet channel (1.2) in the body (1).

Perspective view of body (1) and exhaust gas outlet pipe (5) in demounting position is given in FIG. 25, perspective view of body (1) and exhaust gas outlet pipe (5) in mounting position is shown in FIG. 26.

O-ring (7) is placed into exhaust outlet channel o-ring housing (1.4.1) on the body (1) in order to provide insulation. Exhaust outlet pipe (5) is located into exhaust outlet channel (1.4).

Perspective view of body chamber (1.5) is shown in FIG. 27, semi cross-sectional perspective view of two-equal volume body chamber (1.5) of rolling wall (6) is shown in FIG. 28. Concave wall (6.2) of rolling wall (6) divides body chamber (1.5) into two equal volumes when inserted through rolling wall inlet channel (1.1). They are divided as suction chamber (1.5.1) and combustion chamber (1.5.2).

Perspective view of body (1) parts not installed accessories and ball shaft (2) in demounting position is shown in FIG. 29, perspective view of body (1) parts not installed accessories and ball shaft (2) in mounting position is given in FIG. 30.

A front perspective view of rolling wall (6) on ball shaft (2) is given in FIG. 31, side perspective view of rolling wall (6) on ball shaft (2) is shown in FIG. 32, and a top perspective view of rolling wall (6) on ball shaft (2) is given in FIG. 33. Elliptic disk (2.3) makes rolling motion from concave wall (6.2) of rolling wall (6) from inside of rolling wall seating chamber (2.3.4).

Perspective view of ball shaft (2) inside body (1) not having rolling wall (6) inserted is shown in FIG. 34.

A side perspective view of body (1) with accessories installed is given in FIG. 35 and other side perspective view of body (1) with accessories installed is shown in FIG. 36.

Operation of Device Wherein Rolling/Oscillating Motion is Obtained by Energy Generated as a Result of Combustion of Solid, Liquid or Gas Fuel Oil:

A semi-cross-sectional view of fuel oil spraying to suction chamber (1.5.1) is given in FIG. 37, a semi cross-sectional view of fuel oil compression upon progress of elliptic disk (2.3) in suction chamber (1.5.1) by pressure and narrowing area of elliptic disk (2.3) in combustion chamber (1.5.2) and compression of fuel oil is shown in FIG. 38, a semi cross-sectional view of explosion of fuel oil compressed in combustion chamber (1.5.2) and inlet of fuel oil into suction chamber (1.5.1) again is given in FIG. 39, a semi cross-sectional view of discharge of gas generating in combustion chamber (1.5.2) and supply of fuel oil from combustion chamber (1.5.2) again is given in FIG. 40.

Fuel oil sprayed into suction chamber (1.5.1) from fuel oil injector (3) applies pressure onto elliptic disk (2.3) and forces it to make rotational/cyclic motion (FIG. 37). However, concave wall (6.2) prevents rotational motion. Elliptic disk (2.3) makes rolling motion from concave wall (6.2) of rolling wall (6) from inside of rolling wall seating chamber (2.3.4). It sends fuel oil in the suction chamber (1.5.1) to combustion chamber (1.5.2). Fuel oil explodes as a result of compression by elliptic disk (2.3) in combustion chamber (1.5.2) and applied pressure and heated fuel oil having ignition from ignition bobbin (4) and elliptic disk (2.3) is applied pressure and rolling motion is forced via concave wall (6.2) (see FIG. 38). Simultaneously, fuel oil is filled into suction chamber (1.5.1). Operation of receiving fuel oil and combustion and generation of energy becomes permanent. (FIG. 39, FIG. 40). Fuel oil taking and fuel-oil compressing and explosion thereof by ignition is conducted simultaneously and continuously and not interrupted.

1. A device wherein rolling motion is obtained by energy generated as a result of combustion of solid, liquid or gas fuel oil comprising:
an elliptic disc installed between a symmetric ball comprising two symmetric parts on a ball shaft extending into a body comprising symmetric two parts, a fuel oil injector inlet channel and ignition bobbin inlet channels in the body;
wherein a fuel oil injector is placed to the fuel oil injector inlet channel and ignition bobbins are placed in the ignition bobbin inlet channels;
an exhaust output pipe inserted into an exhaust output channel inside the body;
a rolling wall inserted into a rolling wall inlet channel on the body;
wherein the rolling wall separates a symmetric body chamber it enters into equal volume suction chamber and combustion chamber;
elliptic disk forced to do rolling motion by fuel-oil sprayed into the suction chamber;
the elliptic disk contacting the rolling wall and making rolling/cyclic motion at horizontal position not circular rotation,
as a result of one cycle rolling of the elliptic disk, suction chamber fuel-oil taken into suction chamber is transferred to the combustion chamber;
explosion is achieved as a result of heat of fuel-oil compressed by the elliptic disk in the combustion chamber and start of ignition from the bobbin;
discharge of exhaust gas from explosion to an external environment via an exhaust gas pipe;
fuel oil inlet into the combustion chamber where process is performed is prevented in stage of fuel-oil compression and burning in the combustion chamber;
with the pressure created by explosion in the combustion chamber, elliptic disk touches a concave wall of the rolling wall and upon progressing, fuel-oil entering the suction chamber is transferred back to the combustion chamber;
fuel oil taking and fuel-oil compressing and explosion thereof by ignition is conducted simultaneously and continuously and not interrupted;
rolling/oscillation of the symmetric ball and shaft (2.1) where to symmetric ball is connected upon rolling of the elliptic disk by pressure created in combustion chamber by explosion upon contact to the concave wall;
shaft (2.1) making oscillation/rolling gain motion capability/motion energy;
shaft (2.1) motions are transferred to apparatus by means of a spindle, pipe and similar apparatus to be connected to the shaft (2.1) when required;
characterized in comprising a body, ball shaft, fuel oil injector, ignition bobbins, exhaust output pipe and rolling wall.

2. The device of claim 1, wherein the body comprises two separate parts, namely, a left body and a right body.

3. The device of claim 1, comprising a rolling wall inlet channel insulation housing on the body and a rolling wall inlet channel having a rolling wall seating surface, fuel oil injector inlet channel, ignition bobbin inlet channels, exhaust outlet channel, body chamber, shaft inlet channel, body connection holes, cooler-heater channels, lubrication channels and cooling wings on outer surface sides.

4. The device of claim 1, wherein the ball shaft comprises the shaft, the symmetric ball and the elliptic disk.

5. The device of claim, wherein the symmetric ball comprises two separate parts of symmetric feature, namely, a left ball and a right ball.

6. The device of claim 4, wherein the symmetric ball comprises a shaft passing channel having shaft fixing tab thereon, a disk seating surface and a ball contact surface.

7. The device of claim 4, comprising two separate parts consisting of the elliptic disk, an upper disk and a lower disk.

8. The device of claim 1, wherein the upper disk comprises a tab compressing hole with two tabs, a rolling wall seating chamber and the lower disk with a tab housing compressing hole with two tab housings.

9. The device of claim 8, wherein the upper disk and lower disk combine and form a clutching channel.

10. The device of claim 1, comprising a rolling wall o-ring channel having a cover and the rolling wall containing the concave wall perpendicular to the cover.

11. The device of claim 1, wherein the fuel oil injector is installed onto the fuel oil injector inlet channel.

12. The device of claim 1, wherein the ignition bobbin is installed onto the ignition bobbin inlet channel.

13. The device of claim 1, wherein the exhaust outlet channel is installed onto the exhaust outlet pipe.

14. The device of claim 1, wherein the equal volume suction chamber and combustion chamber are formed in the body chamber in the rolling wall.
